(19) United States
(12) Patent Application Publication
(10) Pub. No.: US 2012/0158336 A1
(43) Pub. Date: Jun. 21, 2012

(54) MANAGEMENT OF A NUMBER OF SWIMMING POOLS

(75) Inventors: Lionel Duchamp, Gruffy (FR); Omar Saaid, Maison Laffite (FR); Jean-Marc Boutet, Le Pecq (FR); Laurent Dousset, Grisy-les-Platres (FR)

(73) Assignee: KIereo, Montesson (FR)

(21) Appl. No.: 13/383,134

(22) PCT Filed: Jul. 9, 2010
(86) PCT No.: PCT/EP2010/059914

§ 371 Date: Mar. 2, 2012

(30) Foreign Application Priority Data
Jul. 10, 2009 (FR) 09 54840
Jul. 10, 2009 (FR) 09 54843
Apr. 20, 2010 (FR) 10 52979

(51) Int. Cl. G06F 19/00

(52) U.S. Cl. 702/81

(57) ABSTRACT

Method for managing a group of swimming pools, characterized in that it includes the following steps:
measurement or estimation of at least one datum representing the water quality of each swimming pool (11; 13; 15; 17) in the group by its own local monitoring means (21; 23; 25; 27),
transmission by the local monitoring means (21; 23; 25; 27) of this at least one datum to a remote server of a management centre (30; 40, 40′) via a communication network (20).

The invention relates to a method for managing a group of individual swimming pools. It also relates to a method for the local monitoring of an individual swimming pool and a server for managing a group of swimming pools. Finally, it relates to a system for managing a group of swimming pools.

In order to manage the water quality of a swimming pool, it is known for certain quantities representing this quality to be measured, such as its pH, for example, and to take action if these quantities fall outside required ranges, by injecting, for example, an acid treatment product if the pH exceeds an authorized maximum. This management of a swimming pool is carried out more or less automatically, in all cases in a non-optimized manner, resulting in shortcomings. These shortcomings manifest themselves in the creation of turbid water, in what is known as a “degraded” condition, the quality of which does not therefore meet the required objectives, and in the creation of a high consumption of resources (water (used by filtration), products, energy), and a non-optimal consumption of swimming pool water processing products. A very large number of physicochemical or bacteriological factors may be the cause of the appearance of a degraded condition of the water of a swimming pool, and several types of such conditions may occur, which makes it very complex to maintain the quality of the water within a predefined range, or indeed prevent it from changing to a degraded condition.

Moreover, if the owner of an individual swimming pool detects an abnormal situation which exceeds his expertise, he will call upon a swimming pool maintenance professional. This is often done too late and the professional has too little information to plan a fast and effective action.

There is therefore a need to improve the management of a swimming pool. More precisely, there is a need to optimize the management of the quality of the water of a swimming pool, consisting in the definition of an optimum compromise allowing an increased water quality to be achieved with a minimized consumption of energy and processing products.

For this purpose, the invention is based on a method for managing a group of swimming pools, characterized in that it comprises the following steps:
measurement or estimation of at least one datum representing the water quality of each swimming pool in the group by its own local monitoring means,
transmission by the local monitoring means of this at least one datum to a remote server of a management centre via a communication network.

The invention is defined more precisely by the claims.

These objects, characteristics and advantages of the present invention will be explained in detail in the following description of a particular embodiment given in a non-limiting manner in relation to the attached figures, in which:

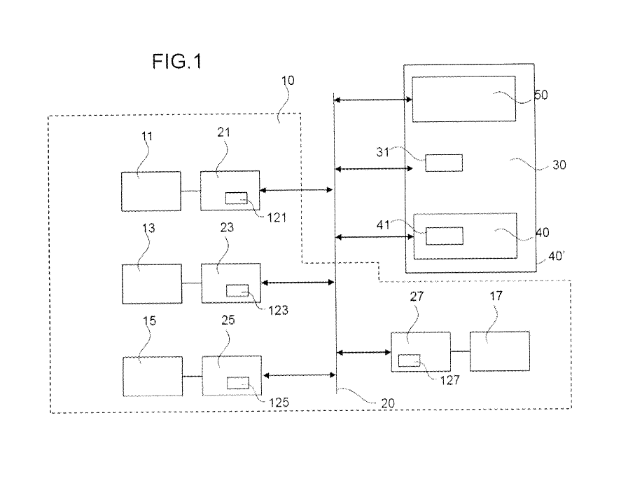

FIG. 1 shows schematically a system for managing a group of swimming pools according to one mode of execution of the invention.

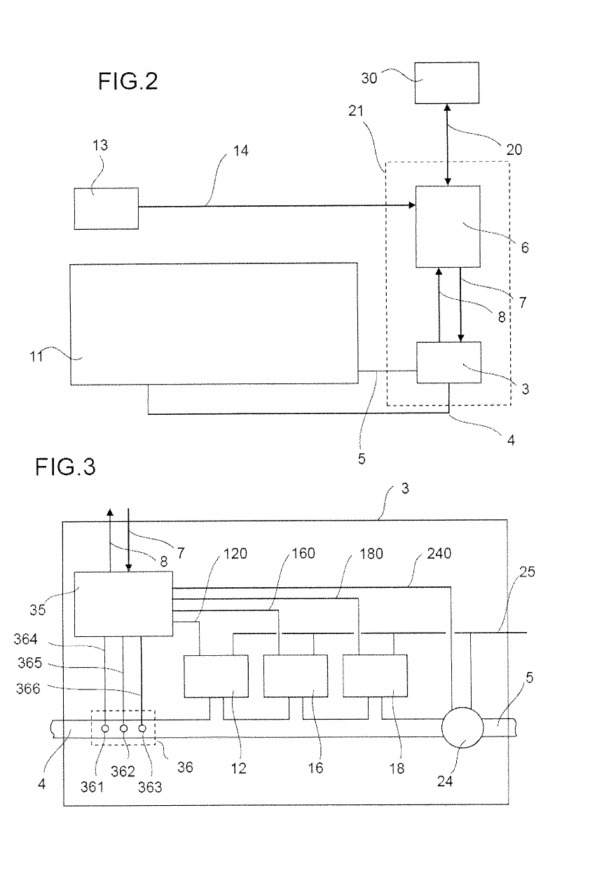

FIG. 2 shows schematically a means for the local monitoring of a swimming pool according to the mode of execution of the invention.

FIG. 3 shows schematically a means for adjusting the local monitoring means of a swimming pool according to the mode of execution of the invention.

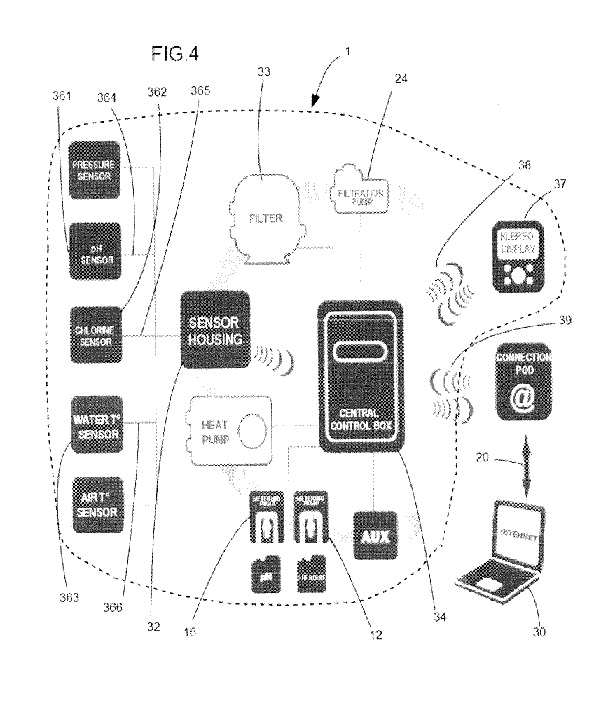

FIG. 4 shows in a different form a device for managing an individual swimming pool integrating a local monitoring means according to the mode of execution of the invention.

The concept of the invention consists in connecting a plurality of individual swimming pools to a management centre, which exchanges parameters and data relating to each swimming pool with a local monitoring means for monitoring the water of each swimming pool. This approach allows a centralized and automated supervision of the swimming pools, which may be offered by a professional, thereby enabling the monitoring and management of each individual swimming pool of a group of swimming pools to be improved, regardless of the distance of these individual swimming pools, which may, for example, be separated by more than one kilometre or more than ten kilometres, without limit to their distance. This approach provides a significant improvement compared with the semi-automatic management of each isolated swimming pool, under the sole supervision of its owner who often has little expertise in this area.

FIG. 1 shows a group of swimming pools 10 according to the invention, in which each swimming pool is linked via a communication network 20 to a management centre 30 for managing this group of swimming pools, which may include a remote central server equipped with management software to manage the group of swimming pools, and also monitoring equipment 40 and 40′ and an information base 50, which may consist of a meteorological server, for example.

The group of swimming pools 10 includes four swimming pools 11, 13, 15, 17, of the uncovered individual swimming pool type, installed in a main or secondary residence, or a hotel, campsite, sports, leisure or fitness centre, etc. Each swimming pool includes a local monitoring means 21, 23, 25, 27 respectively to monitor the water quality, provided with analysis means and processing means, the operation of which will be described below. For simplification and for the purpose of illustrating the principle of the invention, the group shown includes only four swimming pools, but the invention can of course be applied to any number of swimming pools, greater than or equal to two. Each local monitoring means 21, 23, 25, 27 includes signalling means 121, 123, 125, 127 respectively.

The swimming pools and the monitoring means may differ structurally from one swimming pool to another. Thus, the group of swimming pools 10 constitutes a set of heterogeneous elements. However, all of the monitoring means 21, 23, 25, 27 are connected to the same type of communication network 20, for example and preferably a public Internet network.

These monitoring means 21, 23, 25, 27 are connected to a management centre 30 via this communication network 20. The definition of the group of swimming pools results notably from individual subscriptions to the management centre 30 and is represented at least by the presence of identifiers of each local monitoring means or of each swimming pool in a memory 31 of the management centre 30. Conversely, an identifier of the management centre 30 is known to each local monitoring means 21, 23, 25, 27.

Apart from an identifier of each local monitoring means 21, 23, 25, 27 of the swimming pools 11, 13, 15, 17 of the group of swimming pools 10, the management centre 30 has in its memory precise data relating to the location of the swimming pool, its dimensional characteristics, the characteristics of the local monitoring means and, possibly, it also has historical data relating to the physicochemical and bacteriological condition of the water and/or to maintenance operations,

A first monitoring equipment 40 is also connected to the communication network 20. This monitoring equipment is used by a first swimming pool maintenance professional, referred to as a “maintenance agent” or “specialist pool company”, or even an interested owner supervising his swimming pool, that of his neighbours, his family, having concluded a maintenance contract with certain owners of swimming pools in the group, for example those of the first swimming pool 11 and the fourth swimming pool 17.

In the same way, a second monitoring equipment 40′ is used by a second swimming pool maintenance professional who has concluded a maintenance contract with the owners of the second swimming pool 13 and of the third swimming pool 15.

Each monitoring equipment 40, 40′ is known to both the management centre 30 and the monitoring means 21 and 27, 23 and 25 of the subset concerned, at least by a sharing of identifiers.

A monitoring equipment includes a man-machine interface and has in its memory, in the same way as the management centre 30, precise data relating to the location of the swimming pool, its dimensional characteristics, the characteristics of the local monitoring means and, possibly, it also has historical data relating to the physicochemical and bacteriological condition of the water and/or to maintenance operations. These data are preferably recorded by the professional in his monitoring equipment and are then communicated to the management centre.

Due to the possibility of two-way communication on the communication network 20 and the presence of suitable hardware and software means in the monitoring means 21, 23, 25, 27 of the swimming pools, in the management centre 30 and in the monitoring equipment 40, 40′, it is possible to have access from the management centre 30 or from a monitoring equipment 40, 40′ to the data measured by a local monitoring means 21, 23, 25, 27 and/or to effect remote processing operations on this monitoring means. A local monitoring means may also directly alert the corresponding monitoring equipment 40, 40′ and/or the management centre 30 in the event of a serious incident, and notably in the event of predefined thresholds being exceeded, which may result, for example, in a transition to a degraded condition of the water of the corresponding swimming pool.

It should be noted that the monitoring equipment and the management centre may in fact be identical, their functions being performed in such a case by the same remote device, such as a remote server. For example, in a group of swimming pools including relatively few individual swimming pools, a single installer manages the group of swimming pools. His monitoring equipment then becomes the ‘management centre” in the sense of the invention, said centre containing an algorithm suitable for managing the swimming pools in the group. Thus, to simplify the remainder of the description, no further reference will be made to a monitoring equipment and the term management centre will be intended to be interpreted in the broad sense to include any remote swimming pool management, monitoring and supervision device.

Thus, the system of centralized management of a group of swimming pools according to the invention enables the implementation of the following step of a method for managing a group of swimming pools:
Transmission by a local monitoring means of a swimming pool of at least one measurement or datum representing the swimming pool water quality, via a communication means, to a remote server of the management centre.

Notably, the method for managing a group of swimming pools according to the invention includes the transmission of the following measurements to the central server of the management centre 30:
measurement of the water temperature;
measurement of the pH;
measurement of the chlorine or equivalent product, such as salt or bromine or ozone or active oxygen or level of UV production, of disinfectant through electrolysis such as the production of chlorine through salt electrolysis, the function of which is the treatment of the water.

Moreover, the management centre 30 can also be informed of the water filtration periods provided for each swimming pool in the group, store these periods in its memory, receive any modification made locally in the swimming pool, by the local water-monitoring means, for example. It may include a step of measurement of the condition of the filtration, via the pressure or flow rate, for example.

These measurements or data which are significant for managing the water quality of a swimming pool can be transmitted to the management centre periodically, according to a period programmed in the local monitoring means of each swimming pool, this period being modifiable locally or at the request of the management centre. Alternatively, these measures or data can be transmitted at the request of the management centre, or can be transmitted by the local monitoring means following a particular situation, such as a particular measurement, for example a turbid water situation.

These different measurements or data collected on the remote server of the group of swimming pools can be presented to a specialist pool company/supervisor by a man-machine interface allowing the visualization of all these data for each swimming pool, in the same table, for example. The values falling outside predefined ranges can be indicated, by a particular colour code, for example, in order to visualize immediately any abnormal situation, for example corresponding to water which is turbid or is in the process of becoming turbid. Alarms can be triggered automatically for these measurements falling outside predefined ranges. A supervisor can instigate actions remotely to manipulate the different swimming pool monitoring means with a view to improving their water management, for example by initiating a filtration of the water, or adding treatment product. These actions may be automatic, via the transmission of a command from the remote server to the local monitoring means of a swimming pool, which instigates the appropriate actions.

Thus, the method for managing a group of swimming pools according to the invention also allows a local monitoring means of a swimming pool which detects the appearance of a degraded condition of the water of the swimming pool to transmit the information to the management centre immediately. It furthermore includes an automatic processing step as a result of the degraded condition of the water of the swimming pool, implemented by a command of the management centre and/or by a pre-programmed adjustment in the monitoring means.

According to the mode of execution of the invention, the method for managing a group of swimming pools implemented by the software means of the management centre also includes a method for determining swimming pools under threat, i.e. whose water is likely to change to a degraded condition. This method uses a risk criterion. It may also include the use of an expert system, also integrating characteristic data and/or historical data. Some swimming pools may thus be known to present greater sensitivity due to a particular constitution or due to the monitoring means used or even without any particular explanation, but simply due to the fact of historical incidents. The predetermined risk threshold can be adjusted according to this sensitivity specific to each swimming pool and can be acquired, for example, automatically with the aid of the expert system.

According to an advantageous implementation of the invention, the method for determining swimming pools under threat takes account of the degraded condition of adjacent and/or similar swimming pools in order to deduct a probability that this change of condition may occur in another swimming pool in the group. This approach is notably relevant when the transition to the degraded condition of the water of a swimming pool is caused by pollution due to acid rain or some other local meteorological phenomenon likely to contaminate in the same way any swimming pool placed in the same conditions.

In the event of detection of a threat to a certain swimming pool, an alert message is displayed on a screen of the management centre and/or on a screen of the local monitoring means of the swimming pool. In both cases, an LED display, TV, iPad tablet, LCD or OLED can be used.

The local monitoring means of the swimming pool concerned then instigates an appropriate preventive treatment. The preventive treatment can also be implemented remotely by the management centre. In both cases, the local monitoring means of the swimming pool under threat receives a preventive treatment command via the communication network 20.

An option of the local monitoring means allows the owner to accept or reject a direct activation of the local monitoring means by the management centre.

A preventive or remedial treatment may consist in the injection of certain treatment products into the swimming pool, in the closing of a mobile screen protecting the uncovered swimming pool, or any other modification of the condition of the swimming pool. For this purpose, the management centre 30 can act on the local monitoring means of a swimming pool by modifying reference values and/or maximum values and/or minimum values of quantities representing the water quality, such as the pH, chlorine or salt or bromine or ozone or active oxygen or level of UV production, of disinfectant through electrolysis (for example, chlorine production through salt electrolysis), by modifying the time periods of these reference values and/or maximum values and/or minimum values of quantities representing the water quality, by modifying the swimming pool water filtration ranges, by adding treatment products to the swimming pool water or to a suitable reservoir.

According to an advantageous embodiment, all these commands and actions of the management centre relating to a given swimming pool are recorded in the memory 31 of the management centre and/or in a memory of the local monitoring means. This allows the history of the management of each swimming pool to be retained.

The messages can be sent by the management centre 30 in the form of alphanumeric chains. Preferably, at least a part of the message is recorded in a memory of the monitoring means. For example, the content of a signal SIGN is entirely pre-recorded in the local monitoring means 21, just as, for example, the preventive treatment algorithm. The owner simply confirms the instigation of the preventive treatment by pressing a button. In the second alert message MSG2, the management centre then simply sends a code instigating in particular the display of the alert signal. An example of a partially pre-recorded alert signal is as follows:
“Alert” [Threat_Type] “—Treatment” [Treatment_Type] “required as quickly as possible. Press ENTER”

In this example, the management centre simply sends the coded content of the [Threat_Type] and Treatment_Type] variables to the local monitoring means. The local monitoring means contains in its memory the different alphanumeric chains corresponding to the different codes and displays the message corresponding to the received code.

Examples of alphanumeric values for [Threat_Type]=“Acid Rain” or “Sandstorm” or “Pollution”, etc.

Examples of alphanumeric values for [Treatment_Type]=“preventive” or “Chlorine” or “Chlorine and pH” or “UV”, etc.

The hardware and software means of the management centre allowing the application of the management method described above also allow the storage of a correspondence table showing the correspondence between identifiers of each monitoring means.

The invention is independent from the nature of the communication network. The latter may be homogeneous or heterogeneous. For example, in the first case, all the communications are provided via the Internet or all the communications are provided via SMS messages, while, in the second case, some communications can be provided via the Internet while other communications can be provided via SMS messages. It is also possible to transmit a message directly to the owner of a swimming pool by digital telephone messaging of the SMS or voice message type.

The local monitoring means 21 of a swimming pool 11 will now be explained.

FIG. 2 shows an individual swimming pool installation using the method according to the invention. The installation includes a tank 11 and a local control means 21 comprising means for analyzing and adjusting 3 the quality of the water in the tank and connected to the tank by an extraction pipe 4 and an outlet pipe 5.

The local monitoring means 21 also includes supervision means 6 communicating with the adjustment means 3 via a first link means 7, such as a reference line, and via a second link means 8, such as an adjustment information line. The first link means and the second link means are advantageously implemented by two-way radio frequency communication if the adjustment means and the supervision means are physically distant by a plurality of meters.

The supervision means 6 communicate with the remote server of the management centre 30, common to a plurality of installations and dedicated to the monitoring of the group of individual swimming pools, as explained above, via the communication means 20, such as an Internet network. Alternatively, the installation can be linked to a different remote server, not shown in FIG. 2, which may be a meteorological server.

The local monitoring means 21 includes four actuators connected to the water circulation circuit passing from the extraction pipe 4 to the output pipe 5, shown in FIG. 3. A first actuator 12 is, for example, a metering pump, allowing the injection of chlorinated products. A second actuator 16 is, for example, an electrolysis device. A third actuator 18 is, for example, an ozoniser. Alternatively, the third actuator is an ultraviolet radiation device. The fourth actuator 24 is a motor acting on a circulation pump. The water originating from the extraction pipe is thus delivered into the tank via the outlet pipe. Alternatively, other actuators not shown can be used, to interact with a heating device, valves (multi-way or single).

The actuators are powered via an electrical power line 25, for example originating from the AC mains supply, provided with voltage stepdown and/or differential protection means (not shown). The actuators 12, 16, 18, 24 are controlled via control lines, referenced 120, 160, 180, 240 respectively for the actuators. The control lines originate from a microcontroller 35. A physicochemical sensor set 36 includes a first sensor 361, for example a pH sensor, a second sensor 362, for example an optical sensor or chlorine sensor, and a third sensor 363, for example a water temperature sensor. Other sensors can also be used, for example to measure the flow rate and/or pressure of the water or to measure bacterial concentrations. These sensors are connected to the microcontroller via measurement lines, referenced 364 to 366 respectively and perform the function of measurements of quantities representing the quality of the water in the tank 11 and forming a water quality analysis means.

The microcontroller 35 executes an adjustment program of the multi-variable control type, suitable for meeting a water quality criterion by controlling the actuators with the aid of the control lines on the basis of data collected from the measurement lines. Any technique from the field of automation can be used in the adjustment program, including expert system or fuzzy logic rules. In a very simple case of mono-variable adjustment, a PID (Proportional Integral Derivative) control is used and the quality criterion is the PID control reference. A reference value of the quality criterion therefore exists, also referred to as an objective or target value, and also a real value, measured or calculated on the basis of measurements obtained from the measurement lines. The quality criterion is met if the real value differs very little from the reference value, for example by less than 5% or even less than 2%. Beyond a certain deviation from the reference, the water quality is considered to be degraded.

The supervision means 6 and the adjustment means 3 are shown as physically different. This is in fact the case if a first monitoring device includes only the supervision means, whereas an adjustment device contains only the adjustment means. Alternatively, the supervision means, but also a part of the adjustment means, and notably the microcontroller 35, are combined, in order to limit the hardware and software computing resources necessary for the supervision and adjustment means, in a common logical and computing unit (not shown). In all cases, these two adjustment and supervision functions participate in the local monitoring means 21 of the swimming pool 11.

Thus, the local monitoring means 21 of the swimming pool 11 implements a method for monitoring the water quality of an individual swimming pool including adjustment means controlling actuators acting on physicochemical parameters of the water to meet a water quality criterion and including supervision means limiting the action of the actuators by way of function limits fixed at different operating parameters or data, mainly the data representing the swimming pool water quality.

The operating parameter is, for example, the time, and its limits then correspond to at least one authorized time period. A different operating parameter is, for example, the daily or hourly quantity, or, for a certain time period, the quantity of chlorinated products, for which a maximum authorized quantity is predefined. In an equivalent manner, a maximum quantity limit of any treatment product can be predefined. These limits are not exceeded, even if the adjustment provided for by the local monitoring means 21 does not allow the given reference to be reached. In this latter case, the anomaly may originate from a measurement error, for example following a deficiency of a measurement sensor, and the predefined limits allow the unnecessary and sometimes dangerous discharge of a significant quantity of treatment product to be avoided. Otherwise, the local monitoring means of the swimming pool may switch to a different, more suitable operating mode, with different maximum values for the operating parameters, thereby enabling the required water quality to be achieved.

Thus, a plurality of swimming pool water treatment methods can be provided for, in which at least some of these operating limits of the operating data are different: for example, a first mode is more limited and more economical in terms of energy consumption and/or treatment products than a second less limited mode. Following the receipt of information, the local monitoring means 21 of the swimming pool can automatically instigate the transition to the second treatment mode, even though the water quality criterion is met in the first treatment mode, in such a way as to anticipate a future change in the swimming pool water quality.

The operating limits are determined by an installer or are transmitted remotely by the management centre 30. These limits can be automatically determined according to the utilization of a swimming pool, taking into account the number of bathers, by a presence sensor allowing its utilization to be calculated. In fact, the presence of swimmers plays a major role in the requirement for treatment products: bacterial deposits, perspiration, agitation of the water. It is therefore particularly advantageous to anticipate a change of mode according to information linked to the presence of at least one swimmer, and preferably according to information on the number of swimmers, this number being at least estimated. A very low utilization corresponds, for example, to fewer than one user per 40 cubic meters of tank. The absence of utilization or a very low utilization can also be characterized by a condition of total stillness (or quasi-stillness) of the water in the tank. A normal utilization corresponds, for example, to a density of users higher than the preceding case, but remaining lower than one user per 10 cubic meters of tank.

These density thresholds, given as an indication, can be parameterized according to the water temperature, cold water being more tolerant to a high number of users, and/or according to the agitation of the water caused by the users. They can also integrate historical data, and/or be determined by an expert system housed within the management centre 30.

According to a different advantageous step of the method for managing a swimming pool, the information from a meteorological server is taken into account in order to determine the operating mode of the local monitoring means of the swimming pool. For example, information transmitted to the monitoring means, such as a risk of a major storm, for example, causes a change of mode, for example a transition from the medium treatment mode to the strong treatment mode. In fact, stormy weather easily causes a change of condition of the water by encouraging bacterial proliferation. This meteorological information can be transmitted directly by a specific meteorological server 50 or by the server of the management centre 30 of a group of swimming pools which also centralizes the management of the meteorological data.

FIG. 4 shows, in a different form, a device for managing an individual swimming pool integrating a local monitoring means according to the invention.

For this purpose, the management device 1 of the swimming pool, essentially including the local monitoring means of the swimming pool explained above, includes the sensors 361-363 mentioned above, which measure certain quantities representing the water quality, such as, for example, its pH, its chlorine or salt content, its temperature, or additional sensors 367 measuring quantities of the external environment, such as the air temperature. It should be noted that some of these quantities may alternatively be estimated by software rather than measured. These sensors communicate with a central unit 34, possibly via an intermediate housing 32 equipped with a means for wireless communication with the central unit 34, which includes hardware and/or software means, including, for example, the microcontroller 35, to implement the adjustment of the water quality quantities as explained above. It should be noted that the intermediate housing 32 may furthermore perform certain functions such as sampling, switching to standby, etc., in order to optimize its performance and its autonomy.

The central unit 34 monitors the actuators, pumps and other mechanical means to instigate actions consisting, for example, in a recirculation of the water through a filter 33, or in the injection of acid, chlorine, bromine, ozone, active oxygen or UV production treatment products, of disinfectant through electrolysis such as, for example, chlorine production through salt electrolysis. In this way, the central unit 34 can automatically maintain the water quality at a chosen level with an optimized consumption. The principle described above illustrates the normal operation of the local monitoring means of a swimming pool, which will be referred to below as “operating mode”. In this operating mode, the management of the swimming pool is automatic. However, a user retains limited access to certain reference adjustments in order to adapt the behaviour of the swimming pool to its particular use. This interaction of the user with the local monitoring means of the swimming pool is predefined and authorized by the operating mode of the local monitoring means of the swimming pool. This interaction of the user on the local monitoring means of the swimming pool can take place via a remote control 37, which communicates in an advantageous manner via a wireless communication means 38 with the central unit 34, allowing it to be disposed in the immediate vicinity of the swimming pool, while the central unit 34 is housed in an enclosed adjacent location.

Finally, the swimming pool management device is linked via the communication network 20 to a remote central server of a management centre 30, which may be a simple computer. For this purpose, the local monitoring means of the swimming pool is linked 39 locally to the Internet, either by a wired link via a modem, or by a wifi contactless link.

It has been described that the local monitoring means of the management of a swimming pool uses numerous parameters. A technical problem arises during the initialization of these parameters, during its installation and first start-up, or during a subsequent re-initialization. Such an input of parameters and adjustments can be long and tedious. Advantageously, different “typical” swimming pool models are provided, for which the corresponding values of the parameters are stored in a memory of the central server and/or in a memory of a portable object such as a USB memory stick, a memory card, RFID. Thus, when initialization is required, an operative has only to connect his portable object to the local monitoring means of the swimming pool, indicating the corresponding swimming pool model or choosing the portable object corresponding to this model, and all the predefined and pre-recorded initialization values for this swimming pool model are automatically transmitted to the local monitoring means. The installer then simply has to carry out any necessary final adjustments if the chosen model does not perfectly match the swimming pool concerned. This results in a substantial gain in terms of intervention time, while significantly reducing the risks of error.

Moreover, the management centre 30 of the group of swimming pools implements a step of automatic detection of a certain number of maintenance operations or more generally necessary actions on some swimming pools in the group, which require the deployment of a maintenance agent. It can then advantageously facilitate the performance of these operations by the following actions:
presentation on a screen via a man-machine interface of all the swimming pools requiring action, distributed over a geographical map: this allows the maintenance agent to have an immediate global geographical overview of the required actions and to facilitate the organization of his maintenance visits;
presentation on a screen via a man-machine interface of all or part of the data representing the stored past maintenance operations for a given swimming pool;
the central server can even include maintenance visit optimization software, proposing an optimum schedule of visits for each maintenance agent, taking into account, for example, the geographical location of the swimming pools concerned, the nature of the required maintenance operations, the qualifications and availability of each maintenance agent, etc.

The management centre can furthermore include management software to manage its own organization, performing certain calculations relating to the quality of its actions and taking into account the intervention time from the time of detection of the maintenance requirement, the intervention time and the effectiveness of the operations carried out. It is also possible to produce these statistics for each maintenance agent in order to evaluate the individual performance of each of them, to provide relevant training, and more generally to effectively assist the management of the specialist pool company's Human Resources.

Moreover, the fact of centrally managing a group of swimming pools offers additional opportunities for intelligent management of essential resources, such as electricity and water, or treatment products. In fact, in the event of a shortage or threat of shortage of a certain resource in a certain territory, the management centre can provide an emergency shutdown mode, or a low-consumption mode, of all of the group or of some of the swimming pools in the group located in the territory concerned, thereby enabling substantial electricity savings. In fact, the overall electrical consumption of the individual swimming pools of a given territory represents a significant total. This emergency mode triggered by the management centre 30 is automatic and prioritized on the local controls which would be carried out by the local monitoring mean of a swimming pool or by its user or a maintenance agent. This principle similarly applies to the management of the water or to the management of any other resource used by an individual swimming pool. When the shortage or threat of shortage is lifted, the management centre restores the group of swimming pools to its normal operating mode. On the other hand, there may be some situations in which the electricity consumption is too low in relation to the production in a given territory: in an opposite emergency situation of this type, the management centre can force the relevant swimming pools of the group to switch as a matter of urgency to a high electricity consumption operating mode.

1. Method for managing a group of swimming pools, wherein it includes the following steps:
measurement or estimation of at least one datum representing the water quality of each swimming pool in the group by its own local monitoring means,
transmission by the local monitoring means of this at least one datum to a remote server of a management centre via a communication network.

2. Method for managing a group of swimming pools according to claim 1, wherein it includes the transmission to the remote server of the management centre by each local monitoring means of the swimming pools of the group of all or part of the following data:
water temperature;
pH of the water;
quantity of chlorine or equivalent product, such as salt or bromine or ozone or active oxygen or level of UV production, of disinfectant through electrolysis such as the production of chlorine through salt electrolysis, the function of which is the treatment of the water.
periods of filtration of the water or measurement of the condition of the filtration.

3. Method for managing a group of swimming pools according to claim 1, wherein the transmission by a local monitoring means of the at least one datum is carried out in a periodic manner, according to a predefined frequency, fixed or variable according to a step of calculation of this frequency by the local monitoring means of a swimming pool or by the remote server of the management centre of the group of swimming pools, and/or in that the transmission by the local monitoring means of the at least one datum is carried out following the detection of a particular situation by the local monitoring means of a swimming pool, and/or in that the transmission by a local monitoring means of the at least one datum is carried out at the request of the management centre.

4. Method for managing a group of swimming pools according to claim 1, wherein it includes an additional step of storage in a memory of the management centre and/or a local monitoring means of a swimming pool of the at least one transmitted datum.

5. Method for managing a group of swimming pools according to claim 1, wherein it includes a step of transmission to the remote server of the management centre and/or of storage in a memory of the management centre of all or part of the following information:
an identifier of the local monitoring means of at least one swimming pool in the group;
the location of at least one swimming pool in the group;
the dimensional characteristics of at least one swimming pool in the group;
the characteristics of at least one local monitoring means of a swimming pool in the group;
the historical data relating to the physicochemical or bacteriological condition of the water of at least one swimming pool in the group;
the historical data relating to maintenance operations of at least one swimming pool in the group.

6. Method for managing a group of swimming pools according to claim 1, wherein it includes a step of transmission to the remote server of the management centre of the information relating to the transition to a degraded condition of the water of a swimming pool in the group or the threat of transition to a degraded condition by a local monitoring means.

7. Method for managing a group of swimming pools according to claim 1, wherein the remote server of the management centre implements a step of determination of the swimming pools in the group whose water quality is threatened, and a step of transmission of an alert message to a swimming pool in the group whose water quality is threatened.

8. Method for managing a group of swimming pools according to claim 1, wherein it includes a step of remote triggering of a local remedial or preventive treatment operation on a swimming pool via the management centre.

9. Method for managing a group of swimming pools according to claim 1, wherein the treatment operation includes one or more of the following operations:
the injection of at least one treatment product into the swimming pool,
the closure of a mobile screen protecting the uncovered swimming pool,
the modification of reference values and/or maximum values and/or minimum values of quantities representing the water quality, such as the pH, chlorine or salt or bromine or ozone or active oxygen or level of UV production, of disinfectant through electrolysis of the local monitoring means of the swimming pool,
the modification of the time periods of reference values of the local monitoring means of the swimming pool and/or maximum values and/or minimum values representing the water quality of the local monitoring means of the swimming pool,
the modification of the swimming pool water filtration ranges,
the addition of treatment products to an adapted reservoir.

10. Method for managing a group of swimming pools according to claim 1, wherein it includes a step of transmission of at least one limit for a given period to an operating parameter of the local monitoring means of a swimming pool to meet a water quality criterion, such as a maximum limit for a certain period of treatment products such as chlorine, and in that it limits the action of actuators of the local monitoring means by this at least one limit.

11. Method for managing a group of swimming pools according to claim 10, wherein at least one limit of an operating parameter of the local monitoring means of a swimming pool depends on the utilization of the swimming pool.

12. Method for managing a group of swimming pools according to claim 11, wherein at least one limit of an operating parameter of the local monitoring means of the swimming pool depends on at least one density threshold of bathers, this at least one density threshold being parameterized according to the water temperature and/or according to the agitation of the water caused by the users and/or on the basis of historical data and/or by an expert system housed within the management centre.

13. Method for managing a group of swimming pools according to claim 10, wherein the local monitoring means operates according to a plurality of modes predefined by different operating limits of certain operating parameters of the local monitoring means, and in that it includes a step of transmission of a command to change the mode from the management centre to the monitoring means.

14. Method for managing a group of swimming pools according to claim 1, wherein it includes the transmission of meteorological forecasts by a meteorological server or a station local to the management centre or to a local monitoring means of a swimming pool.

15. Method for managing a group of swimming pools according to claim 1, wherein the management centre triggers an emergency mode of all or part of the group of swimming pools in the event of a shortage of a resource such as electricity, water, or a treatment product over a given territory.

16. Method for managing a group of swimming pools according to claim 1, wherein it includes a step of presentation on a geographical map on a man-machine interface of the swimming pool management centre of the swimming pools requiring intervention.

17. Method for managing a group of swimming pools according to claim 1, wherein it includes a step of arranging a round of intervention visits optimized for a plurality of swimming pools in the group according to geographical data and the nature of the intervention to be performed.

18. Method for managing a group of swimming pools, wherein it includes a step of definition of different “typical” swimming pool models, for which the corresponding values of the operating parameters of a local monitoring means of a swimming pool are stored in a memory of a management centre and/or in a memory of a portable object, such as a USB memory stick, a memory card, RFED, and a step of initialization of the local monitoring means of a swimming pool through an input of the swimming pool model, then the transmission of these initialization values from the management centre or from the portable object to the local monitoring means of the swimming pool.

19. Local monitoring means of a swimming pool, wherein it includes hardware and/or software means which carry out the method for managing a group of swimming pools according to claim 18.

20. Server of a management centre of a group of swimming pools, wherein it includes hardware and/or software means which carry out the method for managing a group of swimming pools according to claim 18.

21. System for managing a group of swimming pools, wherein it includes a local monitoring means to monitor the water quality of each swimming pool in the group, connected to a remote server of a management centre via a communication network, and in that it includes hardware and/or software means which carry out the method for managing the group of swimming pools according to claim 18.
